(19) United States
(12) Patent Application Publication
(10) Pub. No.: US 2001/0031061 A1
(43) Pub. Date: Oct. 18, 2001

(54) Speaker apparatus with dual compartment enclosure and internal passive radiator

(76) Inventors: Jeffery James Coombs, Lake Havasu City, AZ (US); Virgil Venditto, Lake Havasu City, AZ (US)

Correspondence Address: Richard E. Oney, FENNEMORE CRAIG, 3003 North Central, Suite 2600, Phoenix, AZ, 85012, US

(21) Appl. No.: 09/756,336

(22) Filed: Jan. 5, 2001

Related U.S. Application Data
(60) Provisional application No. 60/174,615, filed on Jan. 5, 2000.

(51) Int. Cl. H04R 1/02; H04R 1/20

(52) U.S. Cl. 381/349; 381/337; 381/338

(57) ABSTRACT

A speaker apparatus comprises an enclosure including a front panel and having a sealed compartment and a ported compartment. A first driver is mounted in the front panel and within the sealed compartment. An internal passive radiator is mounted in the enclosure. A radial port is formed in the enclosure front panel and is disposed at a position facing the internal passive radiator. The speaker apparatus also includes a second driver mounted in the front panel and within the sealed compartment. The internal passive radiator is mounted between the first and the second drivers.

### RELATED APPLICATION

This application claims the benefit of U.S. Provisional Application No. 60/174,615, filed Jan. 5, 2000, entitled “Internal Passive Radiator within a Dual Chamber Enclosure for Loudspeakers.”

### BACKGROUND

This invention relates to speakers. More particularly, it relates to a speaker apparatus that is suitable for providing improved sound reproduction characteristics over a wide frequency range, with particularly improved reproduction of lower frequency sounds.

FIG. 1 illustrates a commonly known speaker apparatus that utilizes an enclosure known in the art as a “bass reflex,” or ported, enclosure. A bass reflex enclosure uses a port to increase bass output for a given power input, resulting in 2 to 3 dB (decibels) more sound pressure than a similar sealed enclosure. Typically, a port is a specifically tuned circular opening in the enclosure itself with a round tube extending back into the space within the enclosure. As a speaker driver moves in and out to generate sound waves the front of the driver creates the primary sound energy heard, however, the unseen rear side of the speaker also moves air and produces sound waves. The port allows air inside the enclosure to move to the outside of the enclosure in order to improve bass output. A properly ported enclosure allows a speaker driver to perform more efficiently and provide more bass impact for a given input level compared to the same enclosure without a port.

While a ported enclosure is more efficient and able to produce more bass output than a sealed enclosure, a ported enclosure generally does not have as high a level of articulation and detail. Typically, the ported enclosure is more “boomy” (i.e. having lots of bass with poor definition) and less defined than a non-ported enclosure. Additionally, a sealed enclosure is able to reproduce sounds lower in the frequency spectrum compared to a ported enclosure, but not louder for a given input.

Moreover, as a result of this high velocity passage of air through the port of a ported enclosure, a hissing sound may be produced at or near the ends of the port. This hissing sound, or “port noise,” is unwanted and acts generally to deteriorate the quality of the reproduced sound.

In the speaker apparatus of FIG. 1, an enclosure 1 has an interior space that is divided by a partitioning plate 2 into a front compartment 3 and a rear compartment 4. A speaker unit, or driver, 7 is mounted on the partitioning plate 2. The driver 7 has a sound radiating direction that is substantially directed towards the front chamber 3, which is towards the front side of the enclosure 1. An internal duct 101 is mounted through the partition plate 2 so as to extend from the front chamber 3 to the rear chamber 4. The duct 101 allows the passage, or communication, of sound waves between the front chamber 3 and the rear chamber 4.

The interaction between the driver 7, the front and rear chambers 3, 4, and the duct 101 is that of a resonance circuit. The front chamber 3 is adapted to communicate, or allow passage of sound, to the space outside the cabinet 1, in a forward direction (substantially the same direction as the sound radiating direction of the driver 7) by an external duct 6 provided in a front plate 8 of the cabinet 1. The driver 7 has a magnetic circuit 9 and a diaphragm 10. The external duct 6 is mounted within or through an opening 5 that is formed in the front plate 8 of the cabinet 1.

With the speaker apparatus of FIG. 1, the air flows thru internal duct 101 at an increased velocity between front chamber 3 and rear chamber 4. As a result of this high velocity passage of air through the internal duct 101, port noise is produced at or near the ends of the internal duct 101. Moreover, with the speaker apparatus having such an internal duct 101, braking cannot be applied over the entire frequency reproduction range, so that if a larger input signal is applied in succession to the speaker unit, the sound quality tends to be deteriorated. That is, suppression of the high-range standing waves and inhibition of distortion cannot be achieved sufficiently.

As a compromise between ports and completely sealed enclosures, some speaker enclosures include a passive radiator allowing the cabinet to remain sealed while taking advantage of some energy generated inside the enclosure. A passive radiator typically is implemented with a speaker (including a diaphragm) that is not powered. The passive radiator often is used in cooperation with a woofer driver. The diaphragm of the passive radiator is vibrated by the back-pressure of the powered woofer. Rather than being ported, the woofer enclosure is sealed and airtight. The powered woofer moves and creates pressure inside the cabinet, increasing pressure as it moves in and decreasing pressure as it moves out. The passive radiator is moved by these pressure changes being pushed out as the woofer moves in compressing the air inside the cabinet and being pulled in as the woofer cone moves out. The passive radiator allows the back force of the powered woofer to increase sound levels without using a port or opening the cabinet in some other way. This typically results in “tighter,” lower bass more similar to a sealed enclosure, with increased efficiency more like a ported enclosure, but does not fully achieve the efficiency advantages of a ported enclosure.

At least one speaker system has utilized both a passive radiator (with a sealed enclosure) as well a ported enclosure. This speaker system is described in U.S. Pat. No. 5,629,502, to Nakano. This speaker system, however, is not suitable for use with certain advantageous speaker configurations or enclosure types and cannot take advantage of the benefits of such configurations and enclosure types.

One such advantageous configuration is commonly known as a D'Appolito speaker configuration, which is a speaker configuration having a tweeter and two midrange drivers mounted in through-holes in the front panel of the speaker enclosure, with the tweeter positioned on a line between the midrange drivers. As is known in the art, one advantage to the D'Appolito speaker configuration (as opposed to a more traditional configuration with a tweeter, midrange and woofer positioned in a vertical line) is the minimization of floor and ceiling reflections. By placing the tweeter between two midrange drivers, one above and one below, the dispersion of the tweeter's sonic output is more tightly focused by the output of the midrange drivers.

No prior speaker systems have been constructed to benefit from the advantages of a passive radiator, ported enclosure and the D'Appolito speaker configuration.

In view of the foregoing, it is an object of the present invention to provide such a speaker apparatus that utilizes the benefits of a ported enclosure as well as a passive radiator and that is suitable for use with a D'Appolito speaker configuration.

It is another object of the present invention to provide a speaker apparatus having an excellent frequency response, particularly in the lower frequency range, a high efficiency, and improved distortion characteristics.

Additional objects and advantages of the invention will be set forth in the description that follows and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, there is provided a speaker apparatus comprising an enclosure including a front panel and having a sealed compartment and a ported compartment; a first driver mounted in the front panel and within the sealed compartment; an internal passive radiator mounted in the enclosure; and a radial port formed in the enclosure front panel and being at a position facing the internal passive radiator.

In one advantageous embodiment, the speaker apparatus includes a second driver mounted in the front panel and within the sealed compartment, and the internal passive radiator is mounted between the first and the second drivers.

### BRIEF DESCRIPTION OF THE DRAWINGS

The accompanying drawings, which are incorporated in and constitute a part of the specification, illustrate the presently preferred embodiments of the invention and, together with the general description given above the detailed description of given below and the appended claims, will serve to explain the principles of the invention.

FIG. 1 is a cross-sectional side view showing a conventional speaker apparatus having a ported enclosure.

FIG. 2 is a sectional side view showing one embodiment of speaker apparatus according to the present invention.

FIG. 3 is a front elevation view of the speaker apparatus of FIG. 2.

FIG. 4 is a sectional side view showing the internal passive radiator and the ported compartment of the speaker apparatus of FIG. 2 in more detail.

FIG. 5 is a front elevation view of the internal passive radiator and ported compartment shown in FIG. 4.

FIG. 6 is a sectional side view showing another embodiment of speaker apparatus, according to the present invention, having two midrange drivers and a tweeter configured in an enclosure of the D'Appolito type.

FIG. 7 is a front elevation view of the speaker apparatus of FIG. 6.

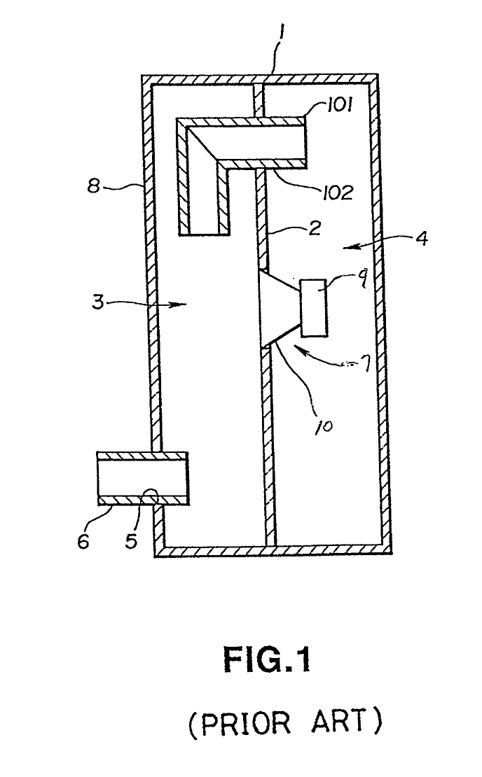

### DESCRIPTION

Reference will now be made in detail to the presently preferred embodiments of the invention as illustrated in the accompanying drawings, in which like reference characters designate like or corresponding parts throughout the drawings.

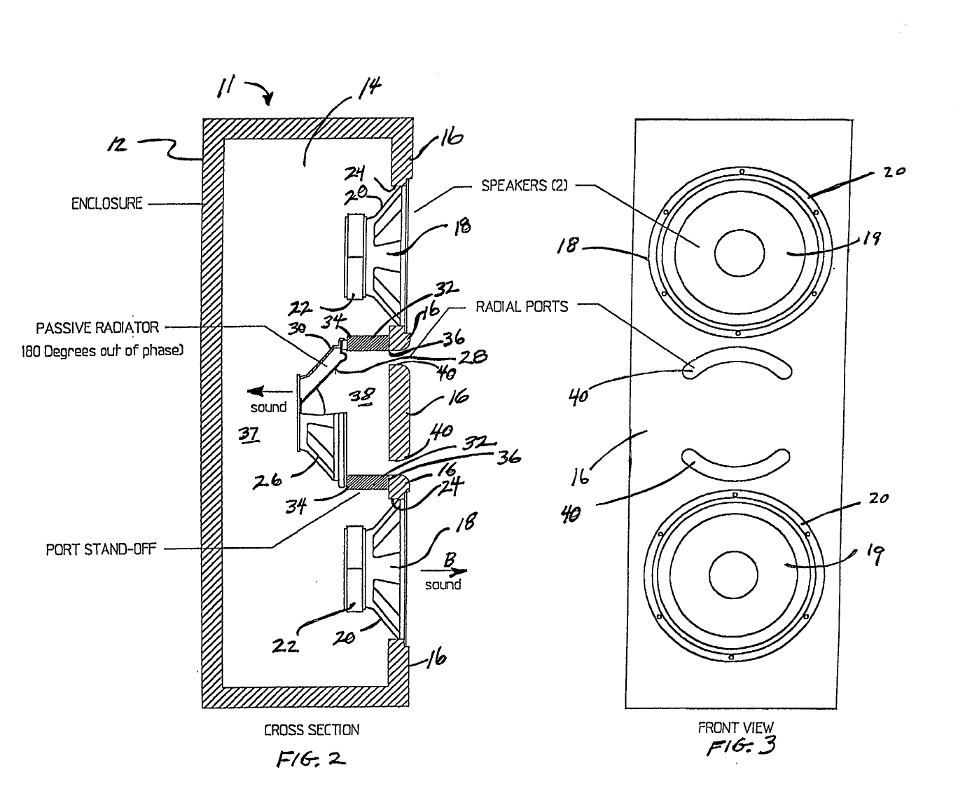

Referring to FIGS. 2 and 3, a speaker apparatus 11 according to the present invention has an enclosure 12. The enclosure 12 is fabricated of a rigid material, for example, wood, wood composite, metal, plastic, composite, carbon fiber, fiber glass or some other synthetic material. The enclosure 12 is constructed in the form of a hollow casing that defines an interior space 14, and includes a front panel 16. Speaker units, or drivers, 18 are mounted on the enclosure front panel 16. Each driver 18 has a diaphragm 19 supported in a fore-and-aft direction by a frame 20, the rear end of which carries a magnetic circuit 22. The magnetic circuit 22 is made up of a yoke and a magnet supported by the frame 20 for defining a magnetic gap and a voice coil mounted on the diaphragm 19 within the magnetic gap. Each driver 18 has a pair of inputs for coupling the driver to an electrical audio input source signal. Each driver 18 has the outer peripheral portion of the frame 20 mounted on the inner peripheral portion of a through-hole 24 formed in the enclosure front panel 16 for closing the through-hole 24. Each driver 18 is supported so that the sound is radiated in a forward direction (indicated by arrow B) to the space outside the enclosure 12.

A passive radiator 26 constituting a resonance circuit is mounted internal to the enclosure 12, as explained in more detail below, between the drivers 18. The internal passive radiator 26 is generally configured like the drivers 18, but without the electro mechanical driver, to reduce a drop-off of the loudness at low frequencies. The passive radiator 26 includes a diaphragm 28 supported by a frame 30 for vibration in the fore-and-aft direction. The passive radiator 26 can have a magnetic circuit (voice coil) mounted on, or attached to, the diaphragm 28. The magnetic circuit can be configured similarly to the magnetic circuit 22 of the drivers 18 and can include a magnet and a yoke supported at a rear end of the frame 30 of the internal passive radiator 26, but the magnetic circuit of the passive radiator 26 is not coupled to an electrical audio input signal.

The peripheral edge of the passive radiator frame 30 is mounted to a cylindrical standoff 32 along the periphery of a first end 34 of the standoff 32. A second end 36 of the cylindrical standoff 32 is mounted to the inner surface of the front panel 16. In this configuration, the interior of the enclosure 12 is divided into relatively large sealed compartment 37 and a smaller ported compartment 38. The ported compartment 38 is bounded by the passive radiator diaphragm 28, the interior wall of the cylindrical standoff 32, and the interior of the front panel 16. The ported compartment 38 is in communication with the space outside and towards the front side of the enclosure 12 (i.e., toward the direction B that is the sound radiating direction) via a radial port 40 in the cabinet front panel 16, as described in more detail below.

In this configuration, the drivers 18 drive the passive radiator 26, but do so at a phase that is 180 degrees out of phase with drivers 18. The diaphragm of the passive radiator is vibrated by the back-pressure of the powered woofer. Because the sealed compartment 37 is substantially sealed and airtight, each of the powered drivers 18 moves and creates pressure inside the cabinet, increasing pressure as the driver diaphragm 19 moves in and decreasing pressure as it moves out. The passive radiator diaphragm 28 is moved by these pressure changes being pushed out as the driver diaphragm 19 moves in, compressing the air inside the sealed compartment 37, and being pulled in as the driver diaphragm 19 moves out, decreasing the pressure in the sealed compartment 37. Thus, passive radiator 26 radiates sound waves in a forward direction B, but 180 degrees out of phase with the sound waves radiated by the drivers 18. In this way, the speaker apparatus 11 “blends” out-of-phase sound waves with the sound waves radiating from the drivers 18.

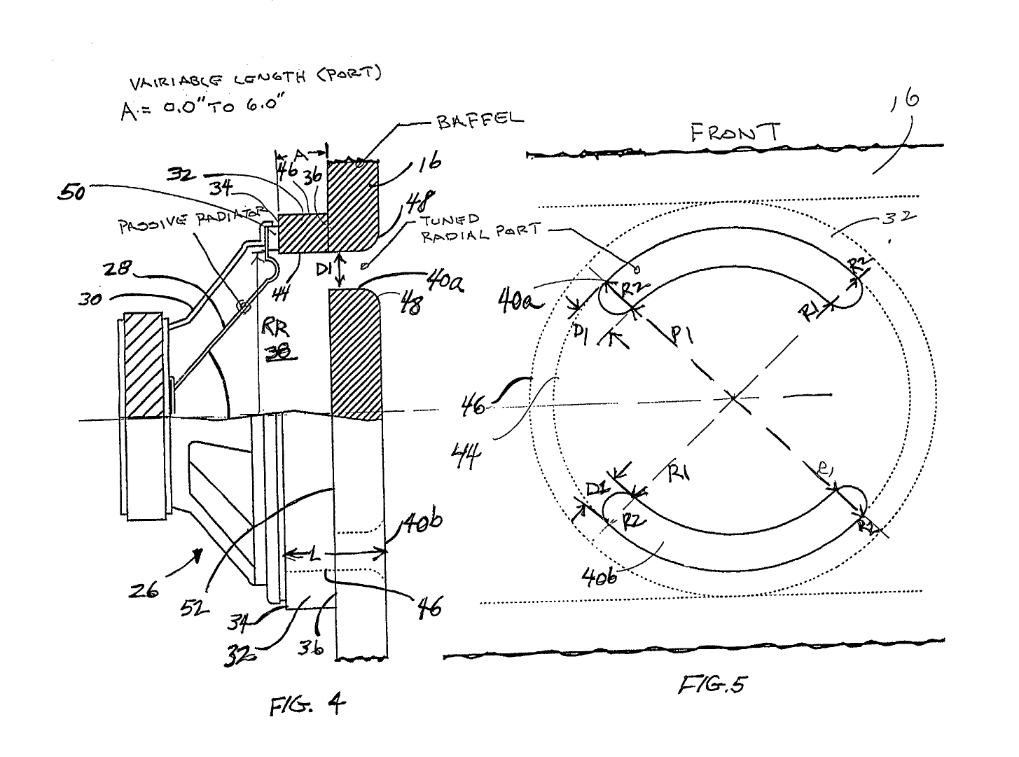

FIGS. 4 and 5 illustrate the internal passive radiator 26, ported compartment 38 and the ports 40 in more detail. As discussed above, the passive radiator from 30 supports the diaphragm 28, which is generally circular in shape. The passive radiator frame 30 has a peripheral edge 50 that is also generally circular in shape and is sized to be roughly proportional to the size of the driver diaphragms 19. The cylindrical standoff 32 is also generally circular in shape and has an interior wall 44 and an exterior wall 46. The first end 34 of the cylindrical standoff 32 is sized to mate with the passive radiator frame peripheral edge 50 so that the passive radiator frame 30 can be mounted to the standoff first end 34 in a sealed relationship. The second end 36 of the cylindrical standoff 32 is mounted in a sealed relationship to the inner surface 52 of the front panel 16. The standoff 32 has a length A upon which the volume of the ported chamber 38 depends. Thus, in the manufacture of the speaker apparatus, volume of the ported chamber 38 can be varied from speaker to speaker by using standoffs of different lengths A.

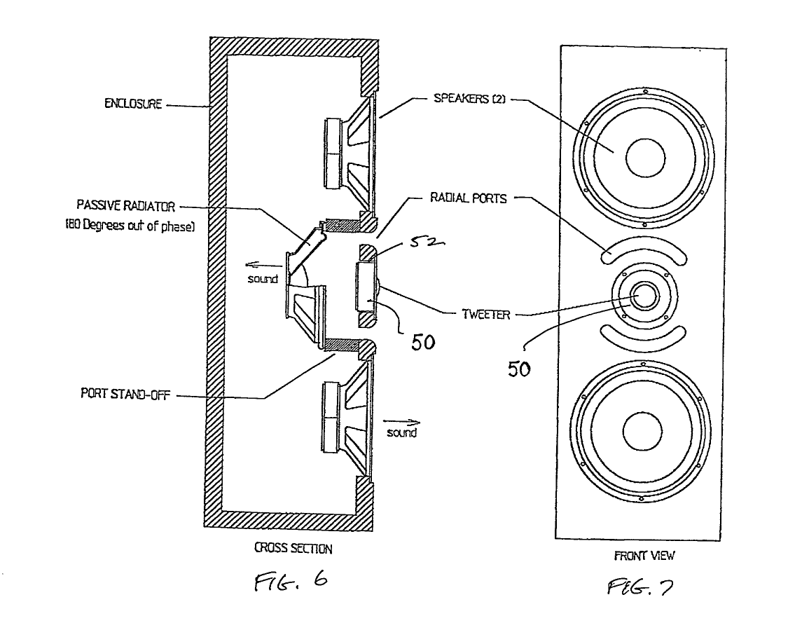

The radial port 40 is formed in the front panel 16 and is generally disposed within the projection of the standoff interior wall 44, so as to provide communication from the ported compartment 38 to the outside of the speaker enclosure. In the embodiment shown in FIGS. 5 and 6, the radial port comprises two elongated port sections 40a, 40b disposed along and within a radius R2 that is approximately matches the radius RR of the circular passive radiator diaphragm 28. Each of the elongated sections 40a, 40b has an inner wall lying on a first radius RI and an outer wall lying along a second radius R2. Each elongated section 40a, 40b is rounded at each of its ends on a diameter D1. In addition, each of the sections 40a, 40b has an opening at the outer surface 48 of the front panel 16 that is flared for reducing port noise.

It will be recognized by those skilled in the art that the radial port 40 may be constructed in other forms. For example, the passive radiator may be non-circular and the radial port may be shaped accordingly to provide communication. For another example, fewer or more port sections may be used. In the configuration shown, the radial port 40 can be tuned to provide a desired frequency response and sound level for a given speaker. This can be done by changing the volume of the ported compartment 38 (which can easily be achieved by using standoffs 32 of different lengths A) and by changing the width and length of the port sections 40a, 40b.

FIGS. 6 and 7 illustrates another embodiment of the speaker apparatus according to the present invention. The speaker apparatus of FIGS. 6 and 7 is in a D'Appolito speaker configuration, i.e. with a tweeter driver 50 “sandwiched” between the two drivers 18, which are midrange drivers in this embodiment. The tweeter 50 is mounted in a through-hole 52 in the enclosure front panel 16 between the radial port sections 40a, 40b in a coaxial relationship with the passive radiator. The speaker apparatus of FIGS. 6 and 7 also includes a crossover circuit for separating the electrical audio input signal into appropriate frequency bands for distribution to the appropriate speaker drivers, i.e. for providing the low and middle frequency input to the midrange drivers 18 and the high frequency input to the tweeter 50. A preferred circuit for achieving this is disclosed in U.S. patent application No. 60/699,029, filed Sep. 21, 2000 and entitled “Loudspeaker Frequency and Distribution Adjusting Circuit.”

In one advantageous embodiment according to the present invention, we have fabricated a speaker apparatus of the type shown in FIGS. 6 and 7. In this embodiment, each of the drivers 18 is a circular 8-inch sandwich cone bass-midrange transducer and the tweeter 50 is a soft dome tweeter. The internal passive radiator 26 is a circular 8-inch passive bass radiator. The standoff 32 has a length A of from one inch in an exemplary embodiment. The enclosure, including the front panel 16, is fabricated using one-inch MDF. The dimensions of each of the two port sections 40a, 40b are: R1=2.75 inches, R2=3.5 inches and D1=0.75 inches.

It has been observed that the speaker apparatus built in accordance with the present invention meets the previously mentioned goals. This speaker has an excellent frequency response particularly in the lower frequency range (plus or minus 2 dB from 50-20,000 Hz), a high efficiency (recommended minimum power for solid state amplifiers 50 watts RMS), and improved distortion characteristics with clean, deep bass reproduction. The overall dimensions of the enclosure 12 are 10.062″ high×29.750″ wide×10.062″ deep.

Additional advantages and modifications will readily occur to those skilled in the art. For example, the number of drivers used may be varied. For another example, the specific shape and location of the ports may be varied. Therefore, the invention in its broader aspects is not limited to the specific details, representative devices, and illustrative examples shown and described. Accordingly, departures may be made from such details without departing from the spirit or scope of the general inventive concept as defined by the appended claims and their equivalents.

What is claimed is:

1. A speaker apparatus comprising:
an enclosure including a front panel and having a sealed compartment and a ported compartment;
a first driver mounted in the front panel and within the sealed compartment;
an internal passive radiator mounted in the enclosure;
a radial port formed in the enclosure front panel and being at a position facing the internal passive radiator.

2. The speaker apparatus as claimed in claim 1 further comprising a second driver mounted in the front panel and within the sealed compartment, wherein the internal passive radiator is mounted between the first and the second drivers.
